(19) United States
(12) Patent Application Publication
(10) Pub. No.: US 2017/0351092 A1
(43) Pub. Date: Dec. 7, 2017

(54) DISPLAY CONTROL APPARATUS, DISPLAY CONTROL METHOD, AND COMPUTER READABLE MEDIUM

(71) Applicant: MITSUBISHI ELECTRIC CORPORATION, Tokyo (JP)

(72) Inventors: Yusuke NAKATA, Tokyo (JP); Michinori YOSHIDA, Tokyo (JP); Masahiro ABUKAWA, Tokyo (JP); Kumiko IKEDA, Tokyo (JP)

(73) Assignee: MITSUBISHI ELECTRIC CORPORATION, Tokyo (JP)

(21) Appl. No.: 15/541,506

(22) PCT Filed: Jun. 30, 2015
(86) PCT No.: PCT/JP2015/068893

§ 371 Date: Jul. 5, 2017

(51) Int. Cl. G02B 27/01; B60R 16/02; G06K 9/00

(52) U.S. Cl. CPC G02B 27/0103; G06K 9/00832; B60R 16/02; G06K 9/00744; G06K 9/00791

(57) ABSTRACT

An object image extraction unit (110) extracts, from a photographed image of ahead of a vehicle, an extracted object image matching an extraction condition among a plurality of object images. A display allocation area specifying unit (130) specifies in the photographed image, an area that does not overlap any extracted object image and that is in contact with any extracted object image, as a display allocation area of guidance information, and identifies an adjacent extracted object image that is in contact with the display allocation area and a tangent of the adjacent extracted object image to the display allocation area. An object space coordinate calculation unit (140) calculates a three-dimensional space coordinate of an object of the adjacent extracted object image, as an object space coordinate. A tangent space coordinate calculation unit (160) calculates, based on the object space coordinate, a three-dimensional space coordinate of the tangent on the assumption that the tangent exists in a three-dimensional space, as the tangent space coordinate. A display area determination unit (170) determines a display area of the guidance information on a windshield, based on the tangent space coordinate and three-dimensional space coordinates of the eye position of a driver and the position of the windshield.

### TECHNICAL FIELD

The present invention relates to a HUD (Head Up Display) technology to display guidance information on a windshield of a vehicle.

### BACKGROUND ART

At a HUD, since guidance information is displayed on a windshield, a part of the front field of view is covered by the guidance information.

Other vehicles, pedestrians, road markings, road signs, traffic lights and the like are objects that should not be overlooked when driving a vehicle. If a driver cannot visually recognize these objects due to the display of the guidance information, the driver may have difficulty in driving.

Patent Literatures 1 to 5 disclose a technology for determining a display area of guidance information which does not interfere with driving by calculation, and the guidance information is displayed on the determined display area.

However, since the height and the eye position differ for each driver, an appropriate display area of the guidance information differs for each driver.

Further, if the posture or sitting position at a time of driving differs even for the same driver, the eye position differs. Thus, the appropriate display area of the guidance information differs for each posture or each sitting position at the time of driving.

In this regard, Patent Literature 6 discloses a technology for displaying guidance information on a windshield according to the eye position of the driver.

### CITATION LIST

### Patent Literature

Patent Literature 1: JP 2006-162442 A

Patent Literature 2: JP 2014-37172 A

Patent Literature 3: JP 2014-181927 A

Patent Literature 4: JP 2010-234959 A

Patent Literature 5: JP 2013-203374 A

Patent Literature 6: JP 2008-280026 A

### SUMMARY OF INVENTION

### Technical Problem

As a method for displaying the guidance information on the windshield so as not to overlap the objects ahead of the vehicle as seen from the driver, a method is considered in which a method of Patent Literature 1 and a method of Patent Literature 6 are combined.

Specifically, a method is considered in which three-dimensional space coordinates of all of the objects ahead of the vehicle as seen from the driver, that is, all of the objects represented in a photographed image are projected onto the projection surface (windshield) of the HUD in accordance with the method of Patent Literature 6, and then the display position of the guidance information not overlapping the objects ahead of the vehicle is obtained by the method of Patent Literature 1 by regarding the projection surface as a single image.

However, with this method, a problem arises that it is necessary to perform projection calculation on all of the objects represented in the photographed image, and a calculation amount is large.

The present invention mainly aims to solve a problem described above. The primary purpose of the present invention is to determine an appropriate display area of guidance information with a small calculation amount.

### Solution to Problem

A display control apparatus mounted on a vehicle in which guidance information is displayed on a windshield, the display control apparatus according to the present invention includes:

an object image extraction unit to extract, from a photographed image photographed ahead of the vehicle, an object image matching an extraction condition among a plurality of object images representing a plurality of objects existing ahead of the vehicle, as an extracted object image;

a display allocation area specifying unit to specify, in the photographed image, an area that does not overlap any extracted object image and that is in contact with any extracted object image, as a display allocation area to be allocated for displaying the guidance information, to identify an adjacent extracted object image being an extracted object image that is in contact with the display allocation area, and to identify a tangent of the adjacent extracted object image to the display allocation area;

an object space coordinate calculation unit to calculate a three-dimensional space coordinate of an object represented in the adjacent extracted object image, as an object space coordinate;

a tangent space coordinate calculation unit to calculate, based on the object space coordinate, a three-dimensional space coordinate of the tangent on assumption that the tangent exists in a three-dimensional space, as a tangent space coordinate; and

a display area determination unit to determine a display area of the guidance information on the windshield, based on the tangent space coordinate, a three-dimensional space coordinate of an eye position of a driver of the vehicle, and a three-dimensional space coordinate of a position of the windshield.

### Advantageous Effects of Invention

In the present invention, since calculation occurs only for an adjacent extracted object image, an appropriate display area of the guidance information can be determined with a smaller calculation amount than that required in a case of performing calculation for all of object images in the photographed image.

### BRIEF DESCRIPTION OF DRAWINGS

FIG. 1 is a diagram illustrating a functional configuration example of a display control apparatus according to a first embodiment.

FIG. 2 is a diagram illustrating an example of extracted object images in a photographed image according to the first embodiment.

FIG. 3 is a diagram illustrating an example of guidance information according to the first embodiment.

FIG. 4 is a diagram illustrating an example of a display allocation area according to the first embodiment.

FIG. 5 is a flowchart diagram illustrating an operation example of the display control apparatus according to the first embodiment.

FIG. 6 is a diagram illustrating a functional configuration example of the display control apparatus according to a third embodiment.

FIG. 7 is a flowchart diagram illustrating an operation example of the display control apparatus according to the third embodiment.

FIG. 8 is a diagram illustrating a functional configuration example of the display control apparatus according to a fourth embodiment.

FIG. 9 is a flowchart diagram illustrating an operation example of the display control apparatus according to the fourth embodiment.

FIG. 10 is a flowchart diagram illustrating the operation example of the display control apparatus according to the fourth embodiment.

FIG. 11 is a diagram illustrating an example of the display allocation area according to the first embodiment.

FIG. 12 is a diagram illustrating an example of the display allocation area according to the first embodiment.

FIG. 13 is a diagram illustrating an outline of a method for determining a display area according to the first embodiment.

FIG. 14 is a diagram illustrating a hardware configuration example of the display control apparatus according to the first to fourth embodiments.

### DESCRIPTION OF EMBODIMENTS

### First Embodiment

### ***Description of Configuration***

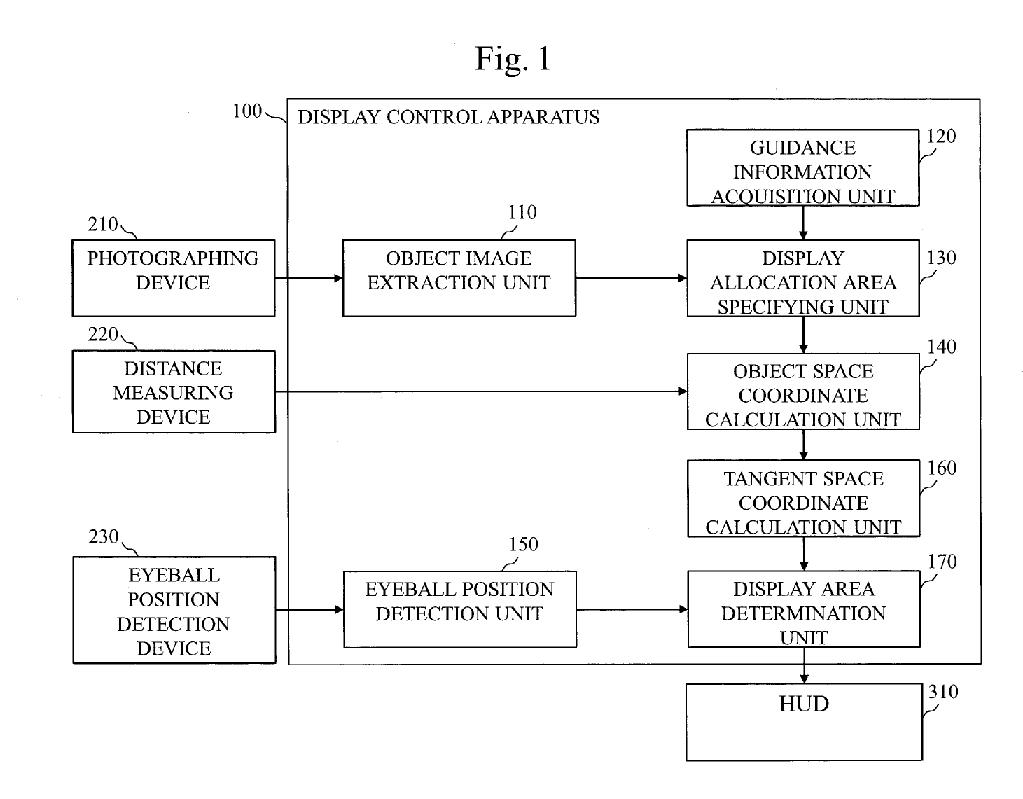

FIG. 1 illustrates a functional configuration example of a display control apparatus 100 according to the present embodiment.

The display control apparatus 100 is mounted on a vehicle being compatible with a HUD, that is, a vehicle in which guidance information is displayed on a windshield.

A functional configuration of the display control apparatus 100 will be described with reference to FIG. 1.

As illustrated in FIG. 1, the display control apparatus 100 is connected to a photographing device 210, a distance measuring device 220, an eyeball position detection device 230 and a HUD 310.

Further, the display control apparatus 100 includes an object image extraction unit 110, a guidance information acquisition unit 120, a display allocation area specifying unit 130, an object space coordinate calculation unit 140, an eyeball position detection unit 150, a tangent space coordinate calculation unit 160, and a display area determination unit 170.

The photographing device 210 is installed in the vicinity of the head of a driver to photograph the scenery ahead of the vehicle.

Any photographing device such as a visible light camera, or an infrared camera can be used as the photographing device 210 as long as it is possible to photograph a photographed image from which an object image can be extracted by the object image extraction unit 110.

The object image extraction unit 110 extracts, from the photographed image photographed by the photographing device 210, the object image matching an extraction condition among a plurality of object images representing a plurality of objects existing ahead of the vehicle, as an extracted object image.

In accordance with the extraction condition, the object image extraction unit 110 extracts an image of an object that should not be overlooked by the driver, and an object that provides useful information for driving.

More specifically, the object image extraction unit 110 extracts images of other vehicles, pedestrians, road markings, road signs, traffic lights, and the like, as extracted object images.

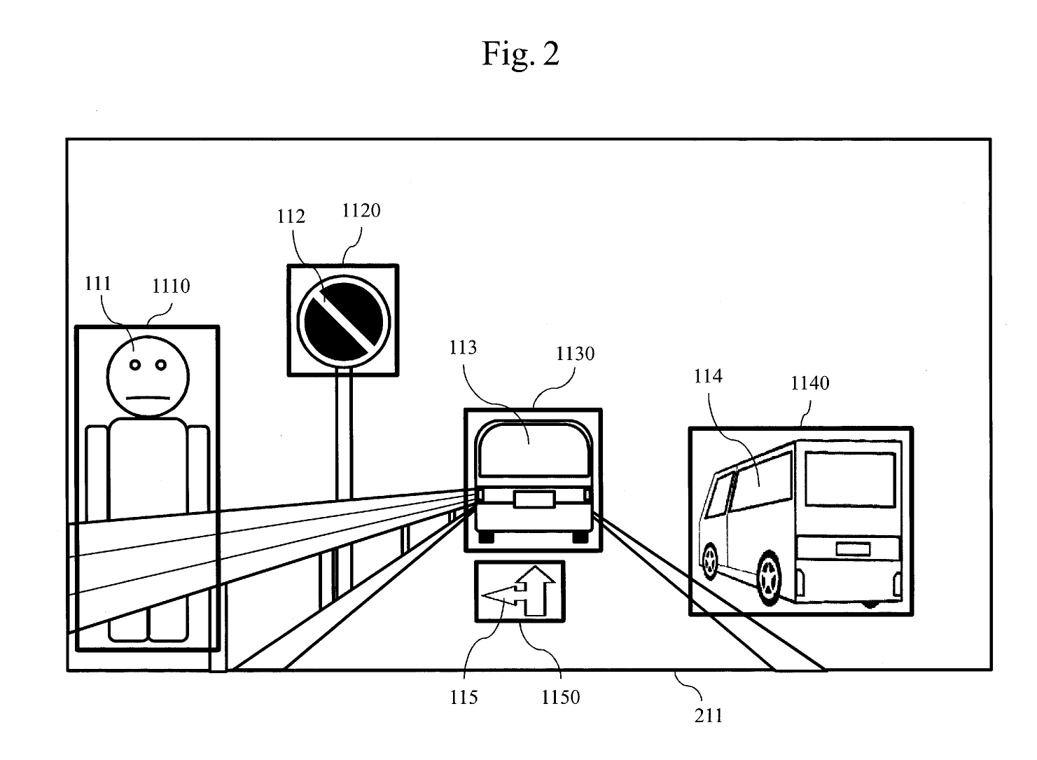

For example, the object image extraction unit 110 extracts, from a photographed image 211 of FIG. 2, a pedestrian image 1110, a road sign image 1120, a vehicle image 1130, a vehicle image 1140, and a road marking image 1150, as extracted object images.

In the pedestrian image 1110, a pedestrian 111 is represented.

In the road sign image 1120, a road sign 112 is represented.

In the vehicle image 1130, a vehicle 113 is represented.

In the vehicle image 1140, a vehicle 114 is represented.

In the road marking image 1150, a road marking 115 is represented.

As indicated by 1110 to 1150 in FIG. 2, the object image is an area where an objects is surrounded by a quadrangular outline.

Note that, there are several well-known techniques as technologies for detecting an object image of a specific object from a photographed image.

The object image extraction unit 110 can extract the object image matching the extraction condition using any well-known technique.

The guidance information acquisition unit 120 acquires the guidance information to be displayed on the windshield.

For example, when guidance information on route guidance such as map information is displayed on the windshield, the guidance information acquisition unit 120 acquires the guidance information from a navigation device.

Further, when guidance information on the vehicle is displayed on the windshield, the guidance information acquisition unit 120 acquires the guidance information from an ECU (Engine Control Unit).

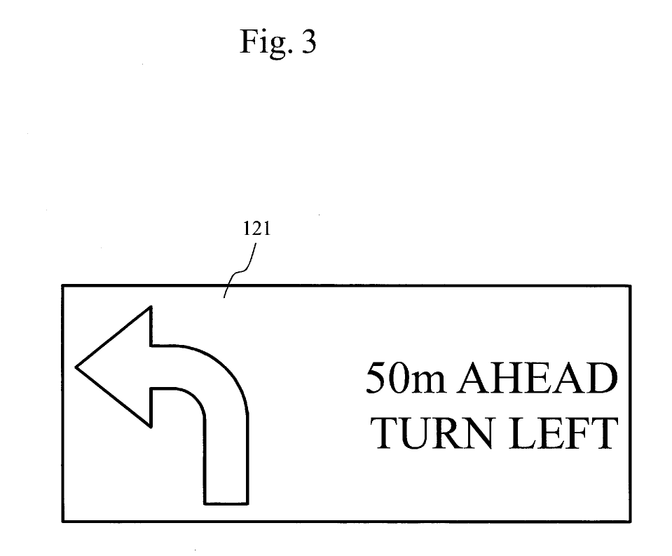

In the present embodiment, the guidance information acquisition unit 120 obtains quadrangular guidance information as indicated by a guidance information 121 of FIG. 3.

The display allocation area specifying unit 130 specifies, in the photographed image, an area that does not overlap any extracted object image and that is in contact with any extracted object image, as a display allocation area to be allocated for displaying the guidance information.

Further, the display allocation area specifying unit 130 identifies an adjacent extracted object image being an extracted object image that is in contact with the display allocation area, and identifies a tangent of the adjacent extracted object image to the display allocation area.

For example, the display allocation area specifying unit 130 scans the guidance information on the photographed image so as to be able to search for the display allocation area.

The display allocation area specifying unit 130 can search for the display allocation area using any technique.

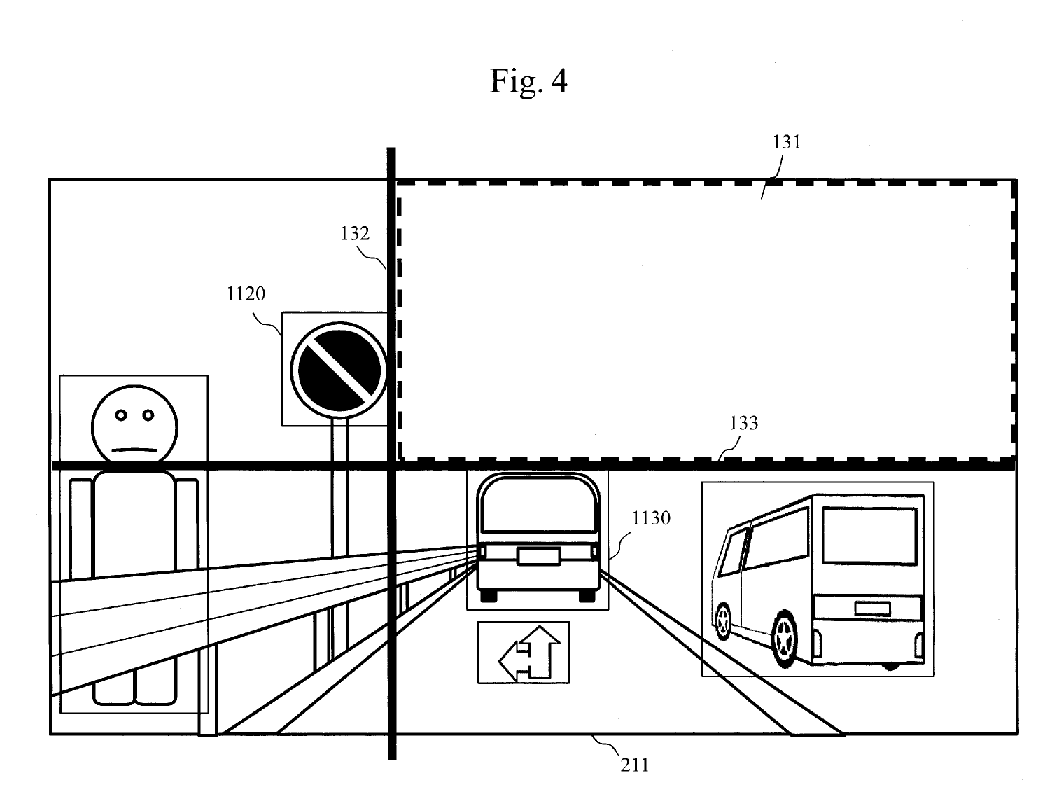

FIG. 4 illustrates an example of the display allocation area specified by the display allocation area specifying unit 130.

In FIG. 4, a display allocation area 131 surrounded by a dashed line is an area where the guidance information 121 can be displayed on the photographed image 211.

The display allocation area 131 in FIG. 4 does not overlap any object image and also is in contact with the road sign image 1120 and the vehicle image 1130.

The display allocation area specifying unit 130 identifies the road sign image 1120 and the vehicle image 1130 as adjacent extracted object images.

Further, the display allocation area specifying unit 130 identifies a tangent 132 of the road sign image 1120 to the display allocation area 131 and a tangent 133 of the vehicle image 1130 to the display allocation area 131.

The display allocation area 131 of FIG. 4 is in contact with the road sign image 1120 and the vehicle image 1130, and the tangent 132 and the tangent 133 are identified.

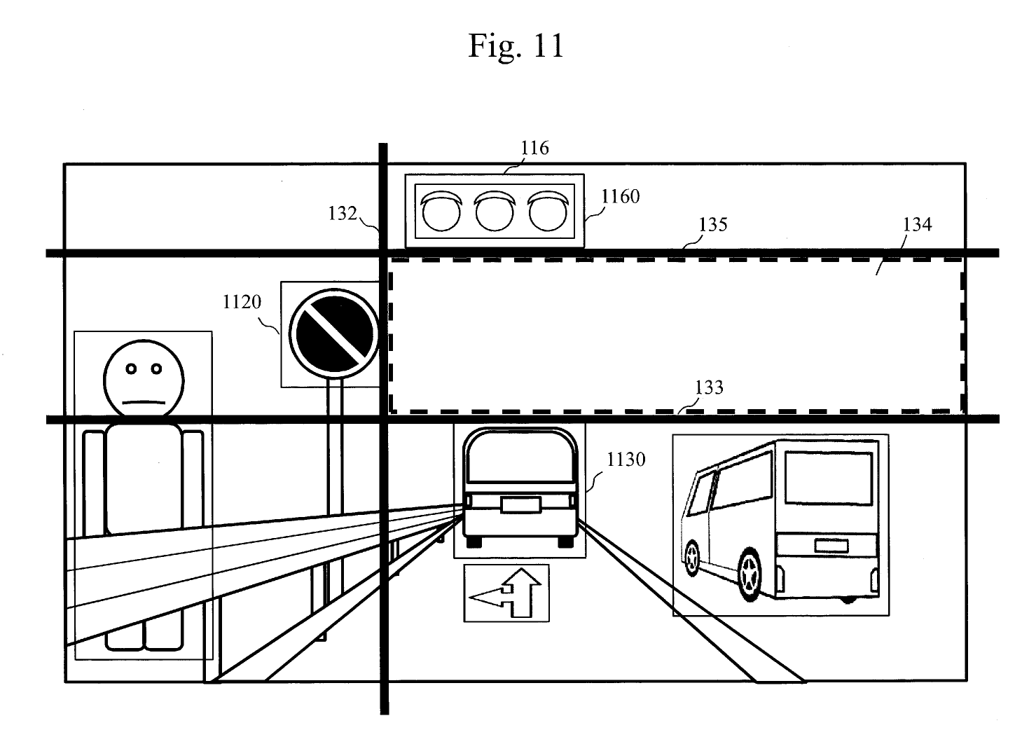

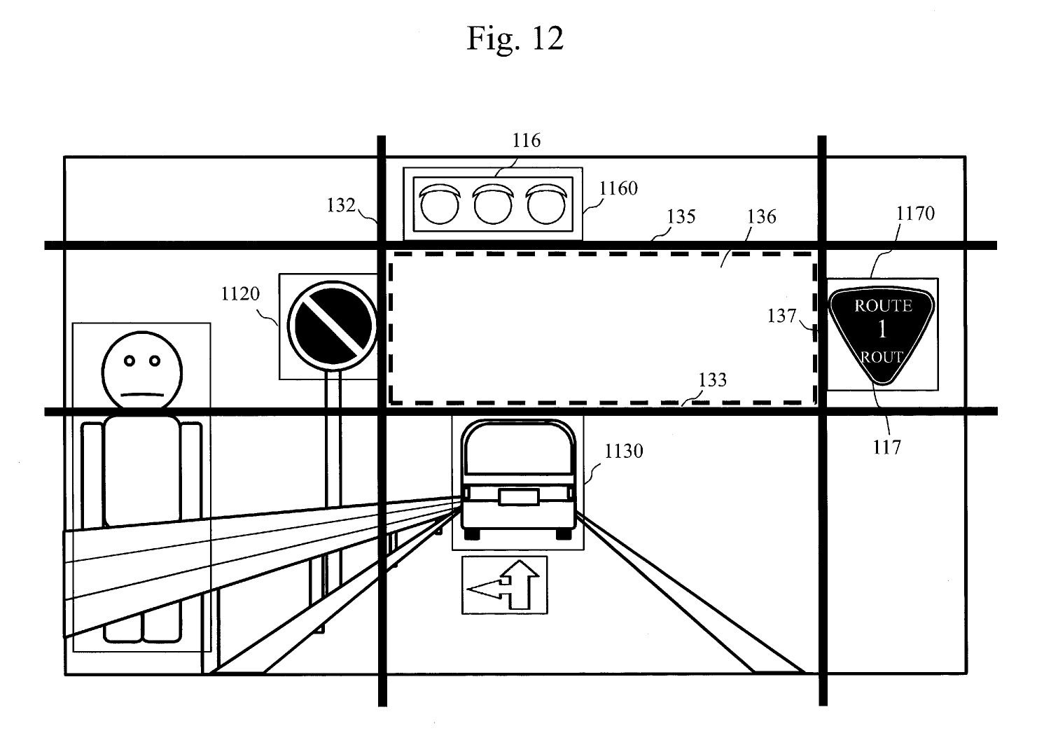

Depending on positions of extracted object images in the photographed image 211, a display allocation area as illustrated in FIG. 11 or 12 is specified.

A display allocation area 134 of FIG. 11 is in contact with the road sign image 1120, the vehicle image 1130, and a traffic light image 1160, and the tangent 132, the tangent 133, and a tangent 135 are identified.

The traffic light image 1160 is an image obtained by photographing a traffic light 116.

Further, a display allocation area 136 of FIG. 12 is in contact with the road sign image 1120, the vehicle image 1130, the traffic light image 1160, and a road sign image 1170, and the tangent 132, the tangent 133, the tangent 135, and a tangent 137 are identified.

The road sign image 1170 is an image obtained by photographing a road sign 117.

Although not illustrated, there may be a case where a display allocation area that is in contact with only one extracted object image is specified.

For example, if the pedestrian image 1110 and the road sign image 1120 are not included in the photographed image 211 of FIG. 2, a display allocation area that is in contact with only the vehicle image 1130 is specified.

In this case, only the tangent 133 is identified.

The distance measuring device 220 measures a distance between an object ahead of the vehicle and the distance measuring device 220.

It is preferable that the distance measuring device 220 measures, with respect to one object, distances from many points on the object.

The distance measuring device 220 is a stereo camera, a laser scanner, or the like.

Any device can be used as the distance measuring device 220 as long as it is possible to identify the distance to the object and the rough shape of the object.

The object space coordinate calculation unit 140 calculates a three-dimensional space coordinate of an object represented in an adjacent extracted object image identified by the display allocation area specifying unit 130, as an object space coordinate.

In the example of FIG. 4, the object space coordinate calculation unit 140 calculates a three-dimensional space coordinate of the road sign 112 represented in the road sign image 1120 and a three-dimensional space coordinate of the vehicle 113 represented in the vehicle image 1130.

The object space coordinate calculation unit 140 calculates three-dimensional space coordinates using distances to the objects (the road sign 112 and the vehicle 113) represented in the adjacent extracted object images measured by the distance measuring device 220, and performs calibration to determine which pixel of the photographed image corresponds to the three-dimensional space coordinates.

The eyeball position detection device 230 detects a distance between an eyeball of the driver and the eyeball position detection device 230.

The eyeball position detection device 230 is, for example, a camera which is installed ahead of a driver, so as to photograph the head of the driver.

Note that, any device can be used as the eyeball position detection device 230 as long as it is possible to measure the distance to the eyeball of the driver.

The eyeball position detection unit 150 calculates a three-dimensional space coordinate of the eyeball position of the driver from the distance between the eyeball of the driver and the eyeball position detection device 230 detected by the eyeball position detection device 230.

The tangent space coordinate calculation unit 160 calculates, based on the object space coordinate calculated by the object space coordinate calculation unit 140, a three-dimensional space coordinate of the tangent on the assumption that the tangent between the display allocation area and the adjacent extracted object image exists in a three-dimensional space, as a tangent space coordinate.

In the example of FIG. 4, the eyeball position detection unit 150 calculates a three-dimensional space coordinate of the tangent 132 on the assumption that the tangent 132 exists in the three-dimensional space, based on an object space coordinate of the road sign image 1120.

Further, the eyeball position detection unit 150 calculates a three-dimensional space coordinate of the tangent 133 on the assumption that the tangent 133 exists in the three-dimensional space, based on an object space coordinate of the vehicle image 1130.

The tangent space coordinate calculation unit 160 determines an equation of the tangent in the three-dimensional space, so as to calculate the three-dimensional space coordinate of the tangent.

Hereinafter, the tangent of the adjacent extracted object image to the display allocation area represented by the equation in the three-dimensional space is called a real space tangent.

The real space tangent is a virtual line along the tangent space coordinate.

The real space tangent is a horizontal or vertical straight line and is on a plane perpendicular to the traveling direction of the vehicle.

In a case where the real space tangent is a perpendicular line (a real space tangent corresponding to the tangent 132 of FIG. 4) to the photographed image, a coordinate in the horizontal direction through which the real space tangent passes is a coordinate of a point closest to the display allocation area in the horizontal direction among object space coordinates of the objects represented in the adjacent extracted object images.

In a case where the real space tangent is a horizontal line (a real space tangent corresponding to the tangent 133 of FIG. 4) to the photographed image, a coordinate in the vertical direction through which the real space tangent passes is a coordinate of a point closest to the display allocation area in the vertical direction among the object space coordinate of the objects represented in the adjacent extracted object images.

The display area determination unit 170 determines a display area of the guidance information on the windshield, based on the tangent space coordinate, the three-dimensional space coordinate of the eye position of the driver of the vehicle, and the three-dimensional space coordinate of the position of the windshield.

More specifically, the display area determination unit 170 calculates, based on the tangent space coordinate, the three-dimensional space coordinate of the eye position of the driver of the vehicle, and the three-dimensional space coordinate of the position of the windshield, the position of a projection line on the windshield obtained by projecting, toward the eye position of the driver of the vehicle, the real space tangent which is a virtual line along the tangent space coordinate, onto the windshield.

Then, in a case where there is one adjacent extracted object image in the photographed image, that is, in a case where there is one tangent in the photographed image, the display area determination unit 170 determines an area surrounded by the projection line and the edge of the windshield, as the display area of the guidance information on the windshield.

Further, in a case where there are a plurality of adjacent extracted object images in the photographed image, that is, in a case where there are a plurality of tangents in the photographed image, the display area determination unit 170 calculates the position of a projection line on the windshield for each real space tangent corresponding to each tangent.

Then, the display area determination unit 170 determines an area surrounded by a plurality of projection lines and the edge of the windshield, as the display area of the guidance information on the windshield.

The guidance information may be displayed anywhere within the determined display area.

The display area determination unit 170 determines the display position of the guidance information within the display area.

The display area determination unit 170 determines, for example, a position where a difference in brightness or hue from the guidance information is large, as the display position.

Determining the display position in this manner prevents the guidance display from being left unseen due to concealment of the guidance display in the background.

Further, this method may be applied to the display allocation area searched by the display allocation area specifying unit 130.

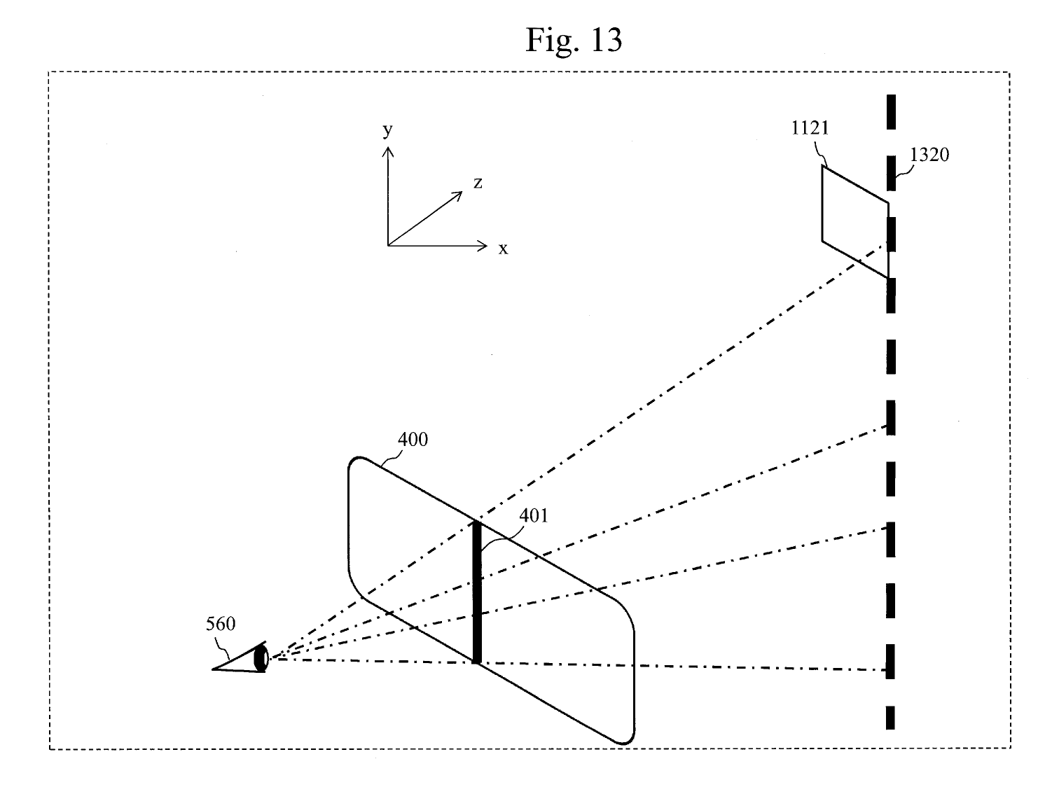

FIG. 13 illustrates an outline of a method for determining the display area by the display area determination unit 170.

FIG. 13 illustrates a three-dimensional coordinate space, with an X axis corresponding to the horizontal direction (the vehicle width direction of the vehicle), a Y axis corresponding to the vertical direction (the vehicle height direction of the vehicle), and a Z axis corresponding to the depth direction (the travelling direction of the vehicle).

An origin (a reference point) of the coordinate in FIG. 13 is a specific position in the vehicle, for example, a position where the distance measuring device 220 is disposed.

A real space tangent 1320 is a virtual line in a three-dimensional space corresponding to the tangent 132 of the road sign image 1120 in FIG. 2 to the display allocation area 131.

A surface 1121 represents the object space coordinate of the road sign 112 represented in the road sign image 1120.

The position on the X axis and the position on the Z axis of the surface 1121 correspond to the distance between the distance measuring device 220 and the road sign 112 measured by the distance measuring device 220.

Since the tangent 132 is a tangent at the right end of the road sign image 1120, if the photographed image 121 which is a two-dimensional image is developed in the three-dimensional space, the real space tangent 1320 is arranged at the right end of the surface 1121.

Note that, the three-dimensional space coordinates on the path of the real space tangent 1320 is the tangent space coordinates.

A windshield virtual surface 400 is a virtual surface corresponding to the shape and position of the windshield.

An eyeball position virtual point 560 is a virtual point corresponding to the eyeball position of the driver detected by the eyeball position detection unit 150.

A projection line 401 is a projection line which is the result of projecting the real space tangent 1320 onto the windshield virtual plane 400 toward the eyeball position virtual point 560.

The display area determination unit 170 projects the real space tangent 1320 onto the windshield virtual plane 400 toward the eyeball position virtual point 560, so as to acquire the position of the projection line 401 on the windshield virtual plane 400 by calculation.

That is, the display area determination unit 170 calculates to obtain the projection line 401 by plotting intersection points on the windshield virtual plane 400 with lines connecting points on the real space tangent 1320 and the eyeball position virtual point 560, so as to calculate the position of the projection line 401 on the windshield virtual surface 400.

### ***Description of Operation***

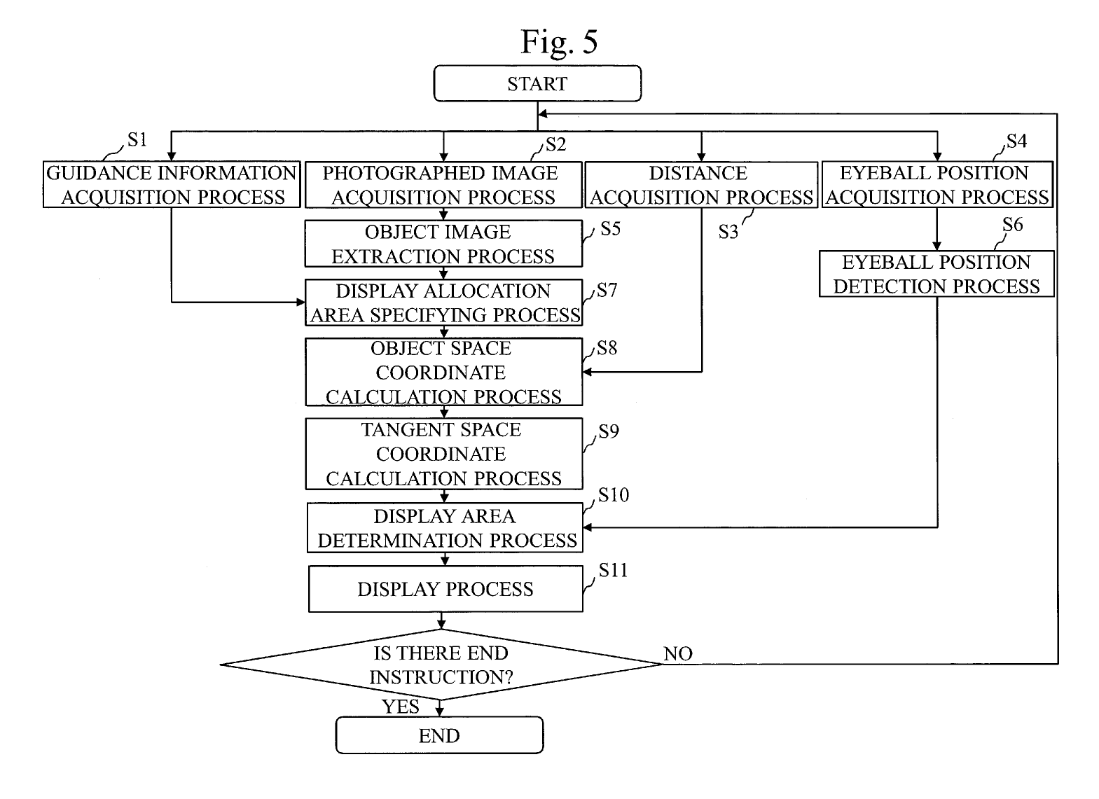

Next, an operation example of the display control apparatus 100, the photographing device 210, the distance measuring device 220, the eyeball position detection device 230, and the HUD 310 according to the present embodiment will be described with reference to FIG. 5.

Note that, an operation performed by the display control apparatus 100 among operation procedures illustrated in FIG. 5 corresponds to an example of each of a display control method and a display control program.

In a guidance information acquisition process of S1, the guidance information acquisition unit 120 acquires the guidance information and outputs the acquired guidance information to the display allocation area specifying unit 130.

Further, in a photographed image acquisition process of S2, the photographing device 210 photographs the ahead of the vehicle to obtain the photographed image.

Further, in a distance acquisition process of S3, the distance measuring device 220 measures the distance between the object existing ahead of the vehicle and the distance measuring device 220.

Further, in an eyeball position acquisition process of S4, the eyeball position detection device 230 obtains the distance between the eyeball of the driver and the eyeball position detection device 230.

Note that, S1 to S4 may be performed concurrently or sequentially.

In an object image extraction process of S5, the object image extraction unit 110 extracts, from the photographed image photographed by the photographing device 210, the object image matching the extraction condition, as the extracted object image.

In an eyeball position detection process of S6, the eyeball position detection unit 150 calculates the three-dimensional space coordinate of the eyeball position of the driver from the distance between the eyeball of the driver and the eyeball position detection device 230 acquired in the eyeball position acquisition process of S4.

Next, in a display allocation area specifying process of S7, the display allocation area specifying unit 130 specifies the display allocation area in the photographed image and identifies the adjacent extracted object image and the tangent.

In an object space coordinate calculation process of S8, the object space coordinate calculation unit 140 calculates the three-dimensional space coordinate of the object represented in the adjacent extracted object image, as the object space coordinate.

Note that, when a plurality of adjacent extracted object images are identified in the display allocation area specifying process of S7, the object space coordinate calculation unit 140 calculates an object space coordinate for each adjacent extracted object image.

In a tangent space coordinate calculation process of S9, the tangent space coordinate calculation unit 160 calculates the tangent space coordinate based on the object space coordinate.

Note that, when a plurality of adjacent extracted object images are identified in the display allocation area specifying process of S7, the tangent space coordinate calculation unit 160 calculates a tangent space coordinate for each adjacent extracted object image.

Next, in a display area determination process of S10, the display area determination unit 170 determines the display area of the guidance information on the windshield, based on the tangent space coordinate, the three-dimensional space coordinate of the eye position of the driver of the vehicle, and the three-dimensional space coordinate of the position of the windshield.

Further, the display area determination unit 170 also determines the display position of the guidance information within the display area.

In a display process of S11, the HUD 310 displays the guidance information at the display position determined by the display area determination unit 170.

Then, the process from S1 to S11 is repeated until there is an end instruction, that is, an instruction to turn off the power of the HUD 310.

### Effect of Embodiment

As described above, in the present embodiment, the display control apparatus 100 specifies the object image (the adjacent extracted object image) surrounding the area (the display allocation area) on which the guidance information can be displayed on the projection surface (the windshield) of the HUD 310 in the photographed image photographed by the photographing device 210.

Therefore, the display control apparatus 100 can determine the display position of the guidance information by merely projecting only the adjacent extracted object image surrounding the display allocation area.

Therefore, it is possible to display the guidance information with a smaller calculation amount of a projection process than that required for a method in which a method of Patent Literature 1 and a method of Patent Literature 6 are combined.

### Second Embodiment.

In the first embodiment, the shape of each of the guidance information, the extracted object image, and the display allocation area is a rectangle.

In the second embodiment, the shape of each of the guidance information, the extracted object image, and the display allocation area is represented by a polygon or a polygon (a combination of polygons each having the same shape).

That is, in the present embodiment, the guidance information acquisition unit 120 acquires guidance information of a p-sided polygon (p is 3 or 5 or more).

Further, the object image extraction unit 110 surrounds an object image matching the extraction condition with an outline of an n-sided polygon (n is 3 or 5 or more) and extracts the object image as the extracted object image.

Further, the display allocation area specifying unit 130 specifies an area of an m-sided polygon (m is 3 or 5 or more) in the photographed image, as the display allocation area.

Note that, in the present embodiment, the number of real space tangents for one adjacent extracted object image is determined based on the shape of the adjacent extracted object image and the shape of the guidance information.

The real space tangent is a straight line passing through the three-dimensional space coordinate corresponding to a pixel in the adjacent extracted object image closest to a pixel of a vertex of a line segment where the display allocation area and the adjacent extracted object image are in contact.

According to the present embodiment, the shape of the guidance information and the shape of the extracted object image can be expressed more finely, and candidates for the display allocation area can be increased.

However, when expressing the extracted object image as a polygon, it is necessary to detect distances from many points on the object with the distance measuring device 220.

### Third Embodiment

In the first embodiment, the shape of the guidance information is fixed.

In the third embodiment, if a display allocation area conforming to the shape of the guidance information is not found, the shape of the guidance information is changed.

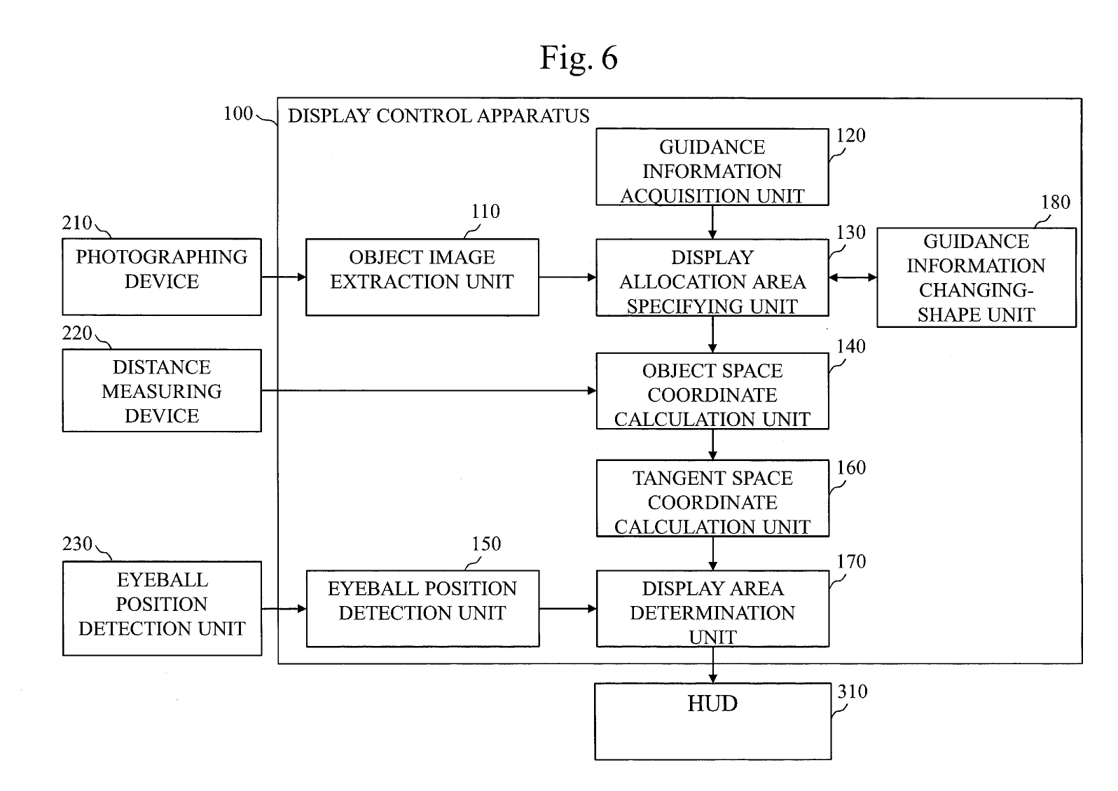

FIG. 6 illustrates a functional configuration example of the display control apparatus 100 according to the present embodiment.

In FIG. 6, a difference from FIG. 1 is that a guidance information changing-shape unit 180 is added.

The guidance information changing-shape unit 180 changes the shape of the guidance information when there is no display allocation area conforming to the shape of the guidance information.

The components other than the guidance information changing-shape unit 180 are the same as those in FIG. 1.

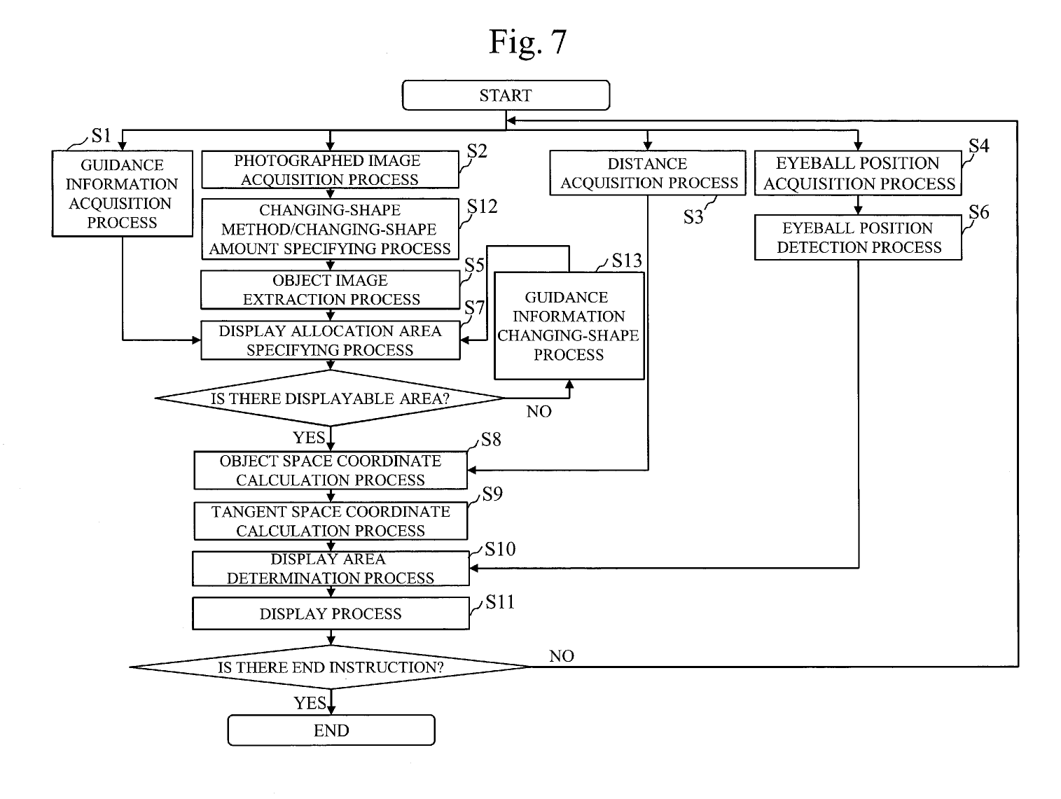

FIG. 7 illustrates an operation example according to the present embodiment.

In FIG. 7, S1 to S4 are the same as those illustrated in FIG. 5, so that the description thereof will be omitted.

In a changing-shape methodchanging-shape amount specifying process of S12, a changing-shape method and a changing-shape amount of the guidance information are specified by the guidance information changing-shape unit 180.

For example, the guidance information changing-shape unit 180 reads out, from a predetermined storage area, data in which the changing-shape method and the changing-shape amount of the guidance information are defined, so that the changing-shape method and the changing-shape amount of the guidance information by the guidance information changing-shape unit 180 are specified.

Note that, the changing-shape method is reduction or compression of the shape of the guidance information.

The reduction is to reduce the size of the guidance information while maintaining the ratio between elements of the guidance information. If the guidance information is a quadrangle, the reduction is to reduce the size of the guidance information while maintaining the aspect ratio of the quadrangle.

The compression is to reduce the size of the guidance information by changing the ratio between the elements of the guidance information. If the guidance information is a quadrangle, the compression is to reduce the size of the guidance information by changing the aspect ratio of the quadrangle.

Further, the changing-shape amount is a reduction amount in one reduction process when the shape of the guidance information is reduced, and is a compression amount in one compression process when the shape of the guidance information is compressed.

S5 to S7 are the same as those illustrated in FIG. 5, so that the description thereof will be omitted.

When the display allocation area specifying unit 130 fails to acquire a display allocation area having a shape conforming to the shape of the guidance information in the display allocation area specifying process of S7, that is, when the display allocation area specifying unit 130 fails to acquire a display allocation area capable of including the default size of guidance information, a guidance information changing-shape process of S13 is performed.

In the guidance information changing-shape process of S13, the guidance information changing-shape unit 180 changes the shape of the guidance information in accordance with the changing-shape method and the changing-shape amount specified in S12.

The display allocation area specifying unit 130 performs the display allocation area specifying process of S7 again and searches for a display allocation area conforming to the shape of the guidance information after the shape has changed.

S7 and S13 are repeated until a display allocation area conforming to the shape of the guidance information is found.

In the present embodiment, when the display allocation area conforming to the shape of the guidance information is not found, the shape of the guidance information is changed, so that candidates for the display allocation area can be increased.

### Fourth Embodiment.

In the first embodiment, it is assumed that the operation procedures illustrated in FIG. 5 are repeated about 20 to 30 times per second.

That is, in the first embodiment, a photographed image is newly obtained by the photographing device 210, and the object image extraction unit 110 extracts an extracted object image from the newly obtained photographed image, at a frequency of 20 to 30 times per second.

Then, the object space coordinate calculation unit 140 specifies a new display allocation area based on the extracted object image newly extracted, at a frequency of 20 to 30 times per second.

In general, however, a combination of objects ahead of the vehicle does not change in milliseconds.

That is, immediately after updating the display of the HUD, it is highly likely that an object adjacent to the display allocation area is the same as that of immediately before.

Therefore, in the present embodiment, it is tracked in each cycle whether or not the extracted object image extracted from the newly obtained photographed image includes the object image identified as the adjacent extracted object image.

Then, when the extracted object image extracted from the newly obtained photographed image includes the object image identified as the adjacent extracted object image, the display allocation area specifying process of S7 is omitted.

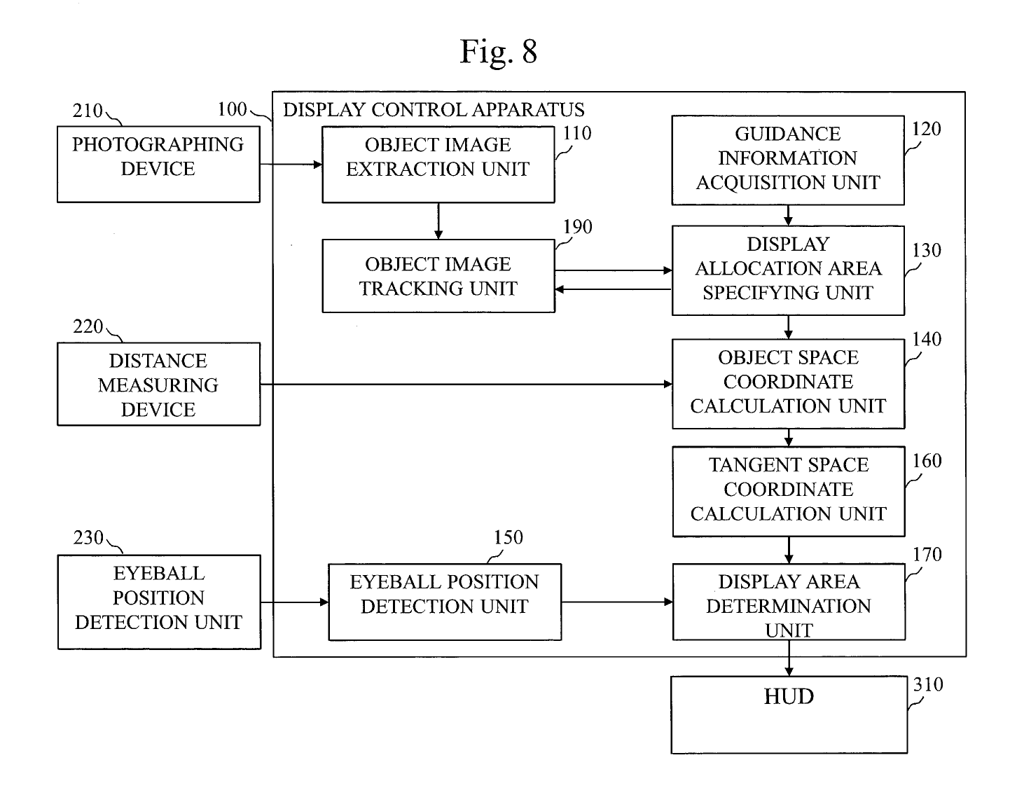

FIG. 8 illustrates a functional configuration example of the display control apparatus 100 according to the present embodiment.

In FIG. 8, a difference from FIG. 1 is that an object image tracking unit 190 is added.

After the display allocation area is specified by the display allocation area specifying unit 130 and the adjacent extracted object image is identified, every time an extracted object image is extracted from the newly obtained photographed image by the object image extraction unit 110, the object image tracking unit 190 determines whether or not the extracted object image extracted by the object image extraction unit 110 includes the object image identified as the adjacent extracted object image.

Then, in the present embodiment, when the object image tracking unit 190 determines that the object image identified as the adjacent extracted object image is included in the extracted object image extracted by the object image extraction unit 110, the display allocation area specifying unit 130 omits to specify the display allocation area.

That is, the display allocation area, adjacent extracted object image, and tangent specified in the previous cycle are reused.

The components other than the object image extraction unit 110 and the object image tracking unit 190 are the same as those in FIG. 1.

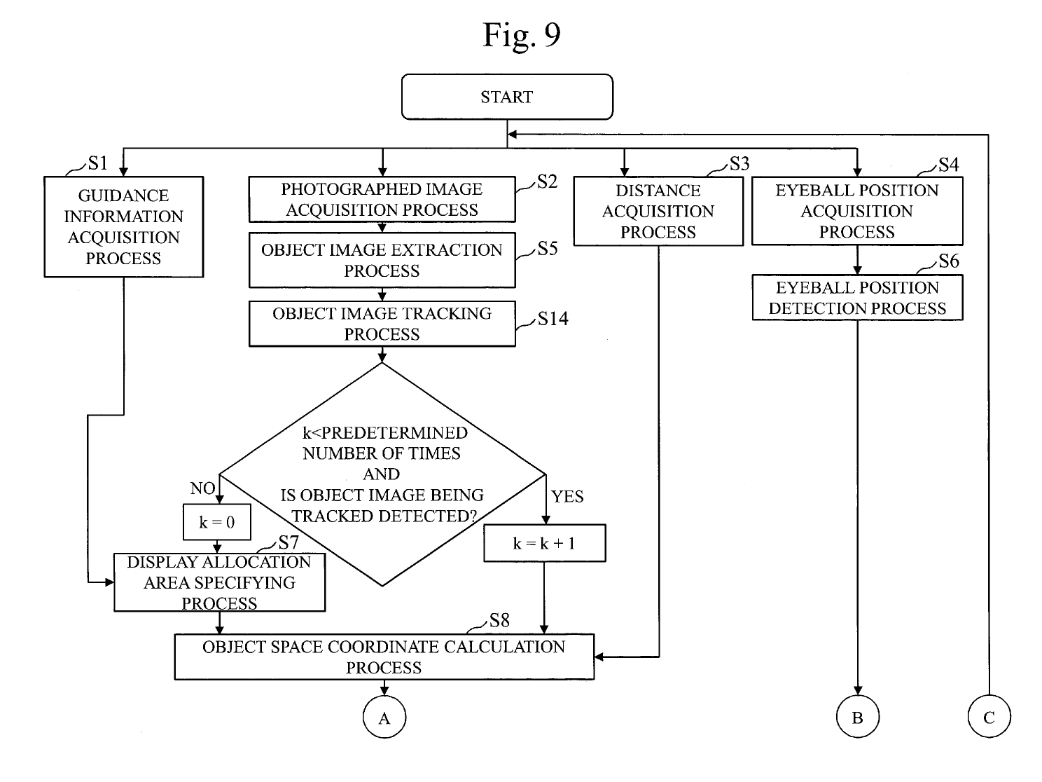

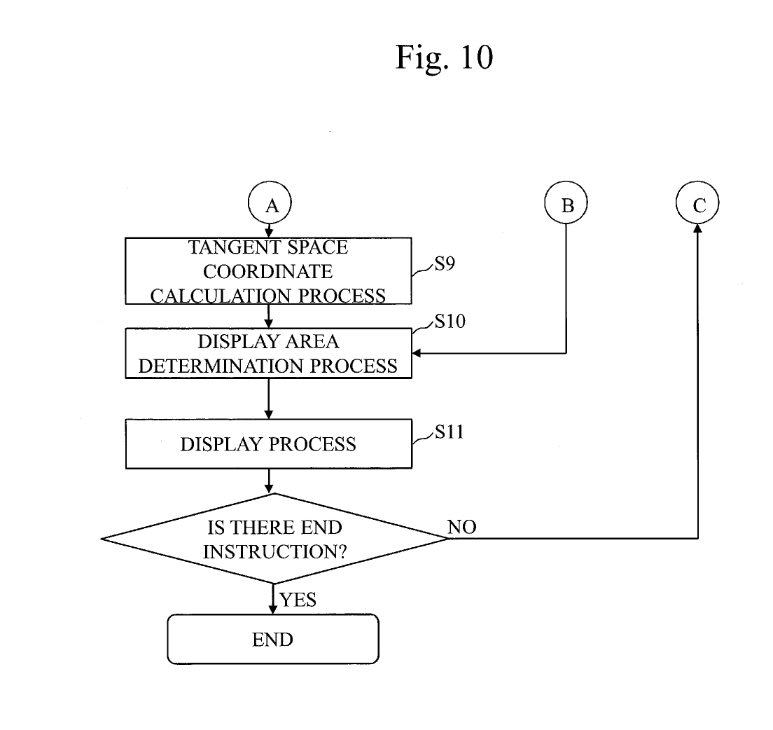

Next, FIGS. 9 and 10 illustrate an operation example according to the present embodiment.

In FIG. 9, S1 to S4 are the same as those illustrated in FIG. 5, so that the description thereof will be omitted.

In an object image tracking process of S14, the object image tracking unit 190 tracks the adjacent extracted image of the display allocation area specified by the object space coordinate calculation unit 140.

That is, the object image tracking unit 190 determines whether or not the object image identified as the adjacent extracted object image is included in the extracted object image extracted from the newly obtained photographed image by the object image extraction unit 110.

The object space coordinate calculation unit 140 determines whether or not a count value k is less than the predetermined number of times and the object image being tracked by the object image tracking unit 190 is detected.

When the count value k is equal to or more than the predetermined number of times or when the object image being tracked by the object image tracking unit 190 is not detected, the object space coordinate calculation unit 140 resets the count value k to “0” and performs the display allocation area specifying process of S7.

The display allocation area specifying process of S7 is the same as that illustrated in FIG. 5, so that the description thereof will be omitted.

Further, processes of S8 onwards are the same as those illustrated in FIG. 5, so that the description thereof will be omitted.

On the other hand, when the count value k is less than the predetermined number of times and the object image being tracked by the object image tracking unit 190 is detected, the object space coordinate calculation unit 140 increments the count value k, and the display allocation area specifying process of S7 is omitted.

As a result, the processes of S8 onwards are performed to the same display allocation area, adjacent extracted object image, and tangent as those in the previous loop.

The processes of S8 onwards are the same as those illustrated in FIG. 5, so that the description thereof will be omitted.

It is preferable that a large value is set to the predetermined number of times when a time required for one round of a flow of FIG. 9 is short, and a small value is set when the time required for one round is long.

For example, it is considered to employ 5 to 10 as the predetermined number of times.

In the present embodiment, by tracking the adjacent extracted image, it is possible to reduce a frequency of searching for the display allocation area, and it is possible to suppress a calculation amount of a display control apparatus.

### ***Description of Hardware Configuration Example***

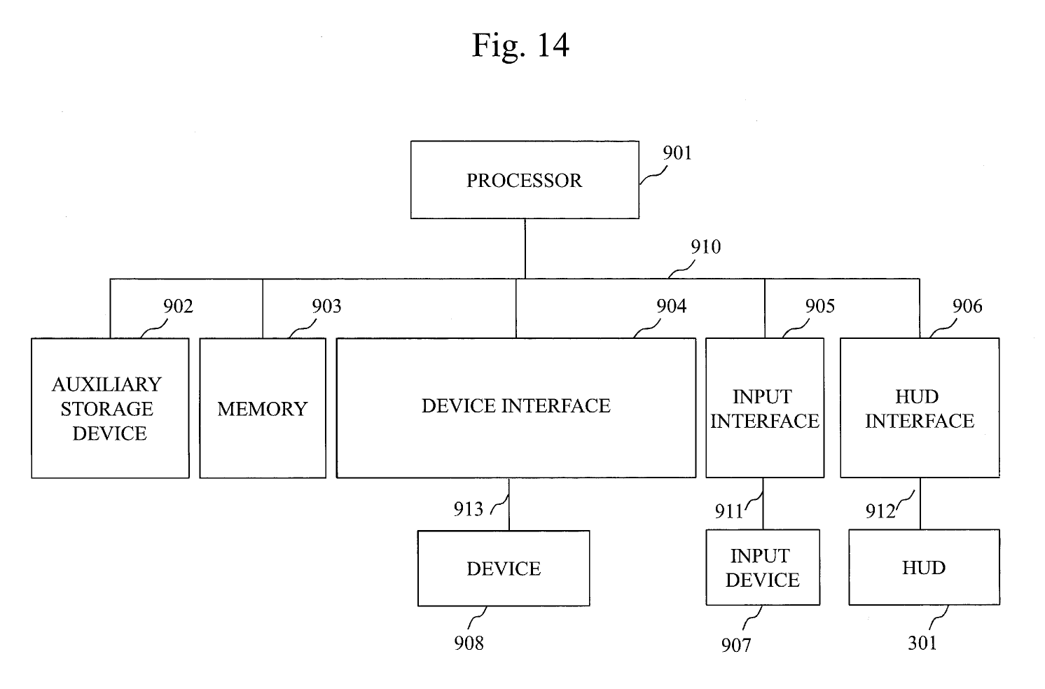

Lastly, a hardware configuration example of the display control apparatus 100 will be described with reference to FIG. 14.

The display control apparatus 100 is a computer.

The display control apparatus 100 includes hardware such as a processor 901, an auxiliary storage device 902, a memory 903, a device interface 904, an input interface 905, and a HUD interface 906.

The processor 901 is connected to other hardware via a signal line 910, and controls these other hardware.

The device interface 904 is connected to a device 908 via a signal line 913.

The input interface 905 is connected to an input device 907 via a signal line 911.

The HUD interface 906 is connected to a HUD 301 via a signal line 912.

The processor 901 is an IC (Integrated Circuit) to perform processing.

The processor 901 is, for example, a CPU (Central Processing Unit), a DSP (Digital Signal Processor), or a GPU (Graphics Processing Unit).

The auxiliary storage device 902 is, for example, a ROM (Read Only Memory), a flash memory, or a HDD (Hard Disk Drive).

The memory 903 is, for example, a RAM(Random Access Memory).

The device interface 904 is connected to the device 908.

The device 908 is the photographing device 210, the distance measuring device 220, or the eyeball position detection device 230 illustrated in FIG. 1 and the like.

The input interface 905 is connected to the input device 907.

The HUD interface 906 is connected to the HUD 301 illustrated in FIG. 1 and the like.

The input device 907 is, for example, a touch panel.

In the auxiliary storage device 902, programs are stored by which functions of the object image extraction unit 110, the guidance information acquisition unit 120, the display allocation area specifying unit 130, the object space coordinate calculation unit 140, the eyeball position detection unit 150, the tangent space coordinate calculation unit 160, and the display area determination unit 170 illustrated in FIG. 1, the guidance information changing-shape unit 180 illustrated in FIG. 6, and the object image tracking unit 190 illustrated in FIG. 8 (hereinafter, these are collectively described as “unit”) are implemented.

These programs are loaded into the memory 903, read into the processor 901, and executed by the processor 901.

Furthermore, the auxiliary storage device 902 also stores an OS (Operating System).

Then, at least a part of the OS is loaded into the memory 903, and the processor 901 executes the programs each of which implements the function of “unit” while executing the OS.

In FIG. 14, one processor 901 is illustrated, but the display control apparatus 100 may include a plurality of processors 901.

Then, the plurality of processors 901 may cooperatively execute the program which implements the function of “unit”.

Further, the memory 903, the auxiliary storage device 902, or a register or a cash memory in the processor 901 stores information, data, a signal value, and a variable value indicating the result of the processing of “unit”.

“Unit” may be provided using “circuitry”.

Further, “unit” may be read as a “circuit”, a “step”, a “procedure”, or a “process”.

The “circuit” and the “circuitry” are each a concept including not only the processor 901, but also other types of processing circuits such as a logic IC, a GA (Gate Array), an ASIC (Application Specific Integrated Circuit), or a FPGA(Field-Programmable Gate Array).

### REFERENCE SIGNS LIST

100: display control apparatus; 110: object image extraction unit; 120: guidance information acquisition unit; 130: display allocation area specifying unit; 140: object space coordinate calculation unit; 150: eyeball position detection unit; 160: tangent space coordinate calculation unit; 170: display area determination unit; 180: guidance information changing-shape unit; 190: object image tracking unit; 210: photographing device; 220: distance measuring device; 230: eyeball position detection device, and 310: HUD.

1. A display control apparatus mounted on a vehicle in which guidance information is displayed on a windshield, the display control apparatus comprising:
processing circuitry to:
extract, from a photographed image photographed ahead of the vehicle, an object image matching an extraction condition among a plurality of object images representing a plurality of objects existing ahead of the vehicle, as an extracted object image;
specify, in the photographed image, an area that does not overlap any extracted object image and that is in contact with any extracted object image, as a display allocation area to be allocated for displaying the guidance information, identify an adjacent extracted object image being an extracted object image that is in contact with the display allocation area, and identify a tangent of the adjacent extracted object image to the display allocation area;
calculate a three-dimensional space coordinate of an object represented in the adjacent extracted object image, as an object space coordinate;
calculate, based on the object space coordinate, a three-dimensional space coordinate of the tangent on assumption that the tangent exists in a three-dimensional space, as a tangent space coordinate; and
determine a display area of the guidance information on the windshield, based on the tangent space coordinate, a three-dimensional space coordinate of an eye position of a driver of the vehicle, and a three-dimensional space coordinate of a position of the windshield.

2. The display control apparatus according to claim 1,
wherein the processing circuity calculates, based on the tangent space coordinate, the three-dimensional space coordinate of the eye position of the driver of the vehicle, and the three-dimensional space coordinate of the position of the windshield, a position of a projection line on the windshield obtained by projecting, toward the eye position of the driver of the vehicle, a virtual line along the tangent space coordinate onto the windshield, and
determines a display area of the guidance information on the windshield, based on the position of the projection line on the windshield.

3. The display control apparatus according to claim 1,
wherein the processing circuitry specifies, in the photographed image, an area that does not overlap any extracted object image and that is in contact with a plurality of extracted object images, as the display allocation area, identifies a plurality of adjacent extracted object image that is in contact with the display allocation area, identifies a tangent to the display allocation area for each adjacent extracted object image,
calculates an object space coordinate for each adjacent extracted object image,
calculates a tangent space coordinate for each adjacent extracted object image, and
determines a display area of the guidance information on the windshield, based on a plurality of tangent space coordinates, the three-dimensional space coordinate of the eye position of the driver of the vehicle, and the three-dimensional space coordinate of the position of the windshield.

4. The display control apparatus according to claim 1,
wherein the processing circuitry surrounds an object image matching the extraction condition with an outline of an n-sided polygon (n is 3 or 5 or more), extracts the object image as the extracted object image, and
specifies an area of an m-sided-polygon (m is 3 or 5 or more) in the photographed image, as the display allocation area.

5. The display control apparatus according to claim 1,
wherein the processing circuitry changes a shape of the guidance information when there is no display allocation area conforming to the shape of the guidance information.

6. The display control apparatus according to claim 1,
wherein the processing circuitry repeats, every time a photographed image is newly obtained, an operation of extracting an extracted object image form a newly obtained photographed image,
determines, after the display allocation area is specified and the adjacent extracted object image is identified, every time an extracted object image is extracted from the newly obtained photographed image, whether or not the extracted object image extracted includes the object image identified as the adjacent extracted object image, and
omits to specify the display allocation area when the processing circuitry determines that the object image identifies as the adjacent extracted object image is included in the extracted object image extracted.

7. A display control method mounted on a vehicle in which guidance information is displayed on a windshield, the display control method comprising:
extracting, from a photographed image photographed ahead of the vehicle, an object image matching an extraction condition among a plurality of object images representing a plurality of objects existing ahead of the vehicle, as an extracted object image;
specifying, in the photographed image, an area that does not overlap any extracted object image and that is in contact with any extracted object image, as a display allocation area to be allocated for displaying the guidance information, to identify an adjacent extracted object image being an extracted object image that is in contact with the display allocation area, and to identify a tangent of the adjacent extracted object image to the display allocation area;
calculating a three-dimensional space coordinate of an object represented in the adjacent extracted object image, as an object space coordinate;
calculating, based on the object space coordinate, a three-dimensional space coordinate of the tangent on assumption that the tangent exists in a three-dimensional space, as a tangent space coordinate; and
determining a display area of the guidance information on the windshield, based on the tangent space coordinate, a three-dimensional space coordinate of an eye position of a driver of the vehicle, and a three-dimensional space coordinate of a position of the windshield.

8. A non-transitory computer readable medium storing a display control program to cause a computer mounted on a vehicle in which guidance information is displayed on a windshield, to execute:
an object image extraction process to extract, from a photographed image photographed ahead of the vehicle, an object image matching an extraction condition among a plurality of object images representing a plurality of objects existing ahead of the vehicle, as an extracted object image;
a display allocation area specifying process to specify, in the photographed image, an area that does not overlap any extracted object image and that is in contact with any extracted object image, as a display allocation area to be allocated for displaying the guidance information, to identify an adjacent extracted object image being an extracted object image that is in contact with the display allocation area, and to identify a tangent of the adjacent extracted object image to the display allocation area;
an object space coordinate calculation process to calculate a three-dimensional space coordinate of an object represented in the adjacent extracted object image, as an object space coordinate;
a tangent space coordinate calculation process to calculate, based on the object space coordinate, a three-dimensional space coordinate of the tangent on assumption that the tangent exists in a three-dimensional space, as a tangent space coordinate; and
a display area determination process to determine a display area of the guidance information on the windshield, based on the tangent space coordinate, a three-dimensional space coordinate of an eye position of a driver of the vehicle, and a three-dimensional space coordinate of a position of the windshield.
